(19) United States
(12) Patent Application Publication
(10) Pub. No.: US 2025/0004818 A1
(43) Pub. Date: Jan. 2, 2025

(54) METHOD AND APPARATUS FOR OPTIMIZING CROSS-DOMAIN DEPLOYMENT OF SFC (SERVICE FUNCTION CHAIN) BASED ON VNF (VIRTUAL NETWORK FUNCTION)

(71) Applicants: Guangdong Polytechnic Normal University, Guangzhou (CN); Guangzhou Xingxi Technology Co., Ltd., Guangzhou (CN)

(72) Inventors: Jun CAI, Guangzhou (CN); Zirui ZHOU, Guangzhou (CN); Jianzhen LUO, Guangzhou (CN); Dao YANG, Guangzhou (CN)

(21) Appl. No.: 18/651,123

(22) Filed: Apr. 30, 2024

(30) Foreign Application Priority Data
Jun. 28, 2023 (CN) 202310770933.8

(51) Int. Cl. G06F 9/455

(52) U.S. Cl. CPC G06F 9/45558; G06F 2009/4557; G06F 2009/45595

(57) ABSTRACT

The present invention belongs to the technical field of network function virtualization and relates to a method and apparatus for optimizing a cross-domain deployment of an SFC (Service Function Chain) based on VNF (Virtual Network Function) migration, a computer device, and a storage medium. The method includes: acquiring a node resource of VNFs and a resource requirement of flow processing; performing the cross-domain deployment of the SFC according to the node resource and the resource requirement; searching for an equilibrium point between a delay and a resource consumption rate of the SFC in combination with the delay and the resource consumption rate of the SFC; and performing optimization processing on the VNF migration according to the equilibrium point to reconstruct the cross-domain deployment of the SFC. First of all, combined with an original deployment of the SFC in a model, whether the VNFs are migrated in the SFC is determined.

### TECHNICAL FIELD

The present invention relates to the technical field of network function virtualization, and particularly relates to a method and apparatus for optimizing a cross-domain deployment of a service function chain (SFC) based on virtual network function (VNF), a computer device, and a storage medium.

### BACKGROUND

Network function virtualization (NFV) has attracted extensive attention as it can realize flexible configuration and management and control of network functions. Based on the NFV technology, service function chain (SFC) defines a group of sequentially connected VNFs, which realizes flexible customization and provision of network services. Due to emergence of NFC, an existing system structure is processed more efficiently, and applications and network functions are created and placed more flexibly and dynamically in network topology, so that management of heterogeneous resources (network, computation, and storage) are optimized. However, the flow of the network will not be kept at a uniform level all the time, and deployment of SFC will always be affected by the unstable network to induce reduction of quality of service (QoS), resulting in reduction of network performance, including service congestion, data loss, jitter and the like.

### SUMMARY

To solve the above technical problems, embodiments of the present invention provide a method and apparatus for optimizing a cross-domain deployment of an SFC (Service Function Chain) based on VNF (Virtual Network Function) migration, a computer device, and a storage medium.

The present invention provides a method for optimizing a cross-domain deployment of an SFC based on VNF migration, including the following steps: acquiring a node resource of VNFs and a resource requirement of flow processing;
performing the cross-domain deployment of the SFC according to the node resource and the resource requirement;
searching for an equilibrium point between a delay and a resource consumption rate of the SFC in combination with the delay and the resource consumption rate of the SFC; and performing optimization processing on the VNF migration according to the equilibrium point to reconstruct the cross-domain deployment of the SFC.

Further, the step of acquiring a node resource of VNFs and a resource requirement of flow processing specifically includes:
constructing an NFV (Network Function Virtualization) architecture; and acquiring the node resource of VNFs and the resource requirement of flow processing via the NFV architecture.

Further, the step of performing the cross-domain deployment of the SFC according to the node resource and the resource requirement specifically includes: selecting a position of the VNF from a plurality of candidate nodes according to the node resource and the resource requirement; and performing the cross-domain deployment of the SFC according to the position of the VNF.

Further, the step of searching for an equilibrium point between a delay and a resource consumption rate of the SFC in combination with the delay and the resource consumption rate of the SFC specifically includes:
counting the delay and the resource consumption rate of the SFC that has been deployed in a cross-domain; and searching for an equilibrium point between the delay and the resource consumption rate of the SFC.

Further, the step of performing optimization processing on the VNF migration according to the equilibrium point to reconstruct the cross-domain deployment of the SFC specifically includes:
removing the VNFs needed to be migrated on an original node according to the equilibrium point; and performing a redeployment of the SFC on the node located at the equilibrium point.

Further, the NFV architecture includes:
a VNF composer, a VNF manager, a virtualized infrastructure manager, and a virtual infrastructure, where the VNF composer is configured to coordinate and manage a software resource and a virtualized hardware infrastructure to implement a service network function; the VNF manager is configured to instantiate, expand, terminate, and update the VNF during use of the VNF, and to automatically update a protocol port; and the virtualized infrastructure manager is configured to virtualize and manage configurable computations, networks, and storage resources, and to further collect infrastructure failure information for capacity planning and overall optimization.

Further, after the step of performing optimization processing on the VNF migration according to the equilibrium point to reconstruct the cross-domain deployment of the SFC, the method further includes:
in a case that an intra-domain controller (IDC) detects that the deployed node fails, implementing the VNF migration on a currently deployed node.

To solve the above technical problems, the present invention further provides an apparatus for optimizing a cross-domain deployment of an SFC based on VNF migration, adopting the following technical solution, including: an acquisition module, configured to acquire a node resource of VNFs and a resource requirement of flow processing;
a deployment module, configured to perform the cross-domain deployment of the SFC according to the node resource and the resource requirement;
an equilibrium module, configured to search for an equilibrium point between a delay and a resource consumption rate of the SFC in combination with the delay and the resource consumption rate of the SFC; and
an optimization module, configured to perform optimization processing on the VNF migration according to the equilibrium point to reconstruct the cross-domain deployment of the SFC.

To solve the above technical problems, the present invention further a computer device, adopting the following technical solution, including a memory and a processor, the memory having a computer readable instruction stored therein and the processor, when executing the computer readable instruction, implementing steps of the method for optimizing a cross-domain deployment of a service function chain (SFC) based on virtual network function (VNF) migration.

To solve the above technical problems, the present invention further a computer readable storage medium, having a computer readable instruction stored therein, where when executed by the processor, the computer readable instruction implements steps of the method for optimizing a cross-domain deployment of a service function chain (SFC) based on virtual network function (VNF) migration.

Compared with the prior art, the present invention mainly has the following beneficial effects: first of all, combined with an original deployment of the SFC in a model, whether the VNFs are migrated in the SFC is determined. Migration processing on the VNF is performed in different scenarios, that is, conditions with stable flow, data surge and failure of a node server, so that the delay, the resource consumption rate and the like of the SFC processing the flow are improved.

### BRIEF DESCRIPTION OF DRAWINGS

To describe the solutions in the embodiments of the present invention more clearly, the drawings required for describing the embodiments are briefly introduced below. Apparently, the drawings in the following description are some embodiments of the present invention, and those of ordinary skill in the art can also be able to acquire other drawings from these drawings without making creative efforts.

FIG. 1 is a flowchart of an embodiment of a method for optimizing a cross-domain deployment of an SFC (Service Function Chain) based on VNF (Virtual Network Function) migration provided by the present invention;

FIG. 2 is a schematic diagram of an NFV (Network Functional Virtualization) architecture used in the method for optimizing a cross-domain deployment of an SFC based on VNF migration provided by the present invention;

FIG. 3 is a schematic diagram of an SDN (Software Defined Network) architecture used in the method for optimizing a cross-domain deployment of an SFC based on VNF migration provided by the present invention;

FIG. 4 is a schematic diagram of a deployment of a cross-domain SFC used in the method for optimizing a cross-domain deployment of an SFC based on VNF migration provided by the present invention;

FIG. 5 is a schematic diagram of a plurality of SFCs deployed in a cross-domain manner used in the method for optimizing a cross-domain deployment of an SFC based on VNF migration provided by the present invention;

FIG. 6 is a schematic diagram of VNF migration when a used node fails in method for optimizing a cross-domain deployment of an SFC based on VNF migration provided by the present invention;

FIG. 7 is a flowchart of the VNF migration used in method for optimizing a cross-domain deployment of an SFC based on VNF migration provided by the present invention;

FIG. 8 is a schematic structural diagram of an embodiment of an apparatus for optimizing a cross-domain deployment of an SFC based on VNF migration provided by the present invention; and

FIG. 9 is a schematic structural diagram of an embodiment of a computer device provided by the present invention.

### DETAILED DESCRIPTION OF EMBODIMENTS

Unless otherwise defined, all technical and scientific terms used herein have the same meaning usually understood by those skilled in the art. The terms used in the specification of the present application herein are merely for the purpose of describing specific embodiments, rather than limiting the present invention. The terms “include” and“have” and any transformations thereof in the specification, claims, and description of drawings of the present invention are intended to cover non-exclusive inclusion. The terms “first”, “second” and the like in the specification and claims or drawings of the present invention are used to distinguish different objects, rather than describing a specific order.

The “embodiments” herein mean that specific features, structure or characteristics described in combination with the embodiments may be included in at least one embodiment of the present invention. The phrase appearing at each position of the description does not necessarily indicate the same embodiment and it is not an exclusively independent or alternative embodiment of other embodiments. Those skilled in the art explicitly and implicitly understand that the embodiments described herein may combine with other embodiments.

In order to make those skilled in the art better understand the solutions of the present invention, the technical solutions in the embodiments of the present invention will be described clearly and intactly below in combination with drawings.

It is to be noted that the method for optimizing a cross-domain deployment of an SFC based on VNF migration provided the embodiments of the present invention is usually executed by a server/terminal device, and correspondingly, the apparatus for optimizing a cross-domain deployment of an SFC based on VNF migration is usually arranged in the server/terminal device.

It is to be understood that the numbers of the terminal devices, networks, and servers can merely be schematic. According to implementation needs, there may be any number of terminal devices, networks, and servers.

### Embodiment I

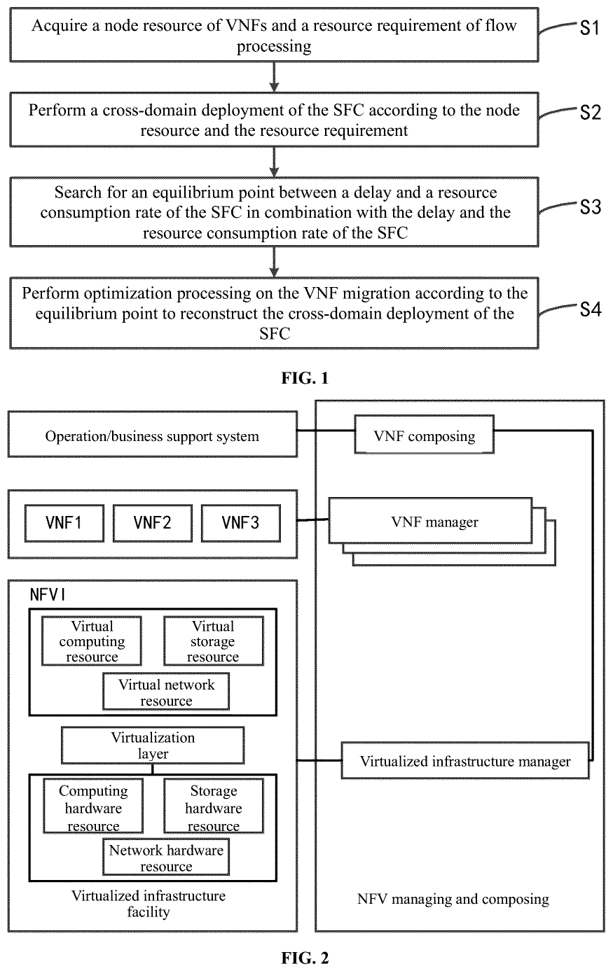

FIG. 1 shows a flowchart of an embodiment of a method for optimizing a cross-domain deployment of an SFC (Service Function Chain) based on VNF (Virtual Network Function) migration provided by the present invention. The method for optimizing a cross-domain deployment of an SFC based on VNF migration provided by the present invention includes the following steps:
S1: a node resource of VNFs and a resource requirement of flow processing are acquired.

In the embodiment, an electronic device (for example, the server/terminal device shown in FIG. 1) running on the method for optimizing a cross-domain deployment of an SFC based on VNF migration can receive a request for optimizing the cross-domain deployment of the SFC based on VNF migration in a wired/wireless connection mode. It is to be pointed out that the wireless connection mode can include, but is not limited to, 3G/4G/5G connection, WiFi connection, Bluetooth connection, WiMAXX connection, Zigbee connection, ultra wideband (UWB) connection and other existing known or futurely developed wireless connection modes.

In the embodiment, step S1 can further include the following step:
S11: an NFV (Network Function Virtualization) architecture is constructed.

The NFV architecture is an architecture where software and hardware are separated and the network functions are virtualized. A significant characteristic of NFV is that the conventional network functions depending on hardware equipment are converted to software modules, which is a network design to realize efficient network functions and services. Its main idea is to decouple the network functions (for example, firewall, load balancing, and video caching) from dedicated hardware and run the network functions on software on a standard server in the industry, that is, the so called virtual network functions. The implementation cost is low, and the infrastructure is flexible to configure. NFV is to divide network node functions into several function blocks by using universal hardware and virtualization technology (to run a plurality of operating systems simultaneously by using one computer), and to implement the functions respectively in a software mode, that is, the universal hardware carries software processing of more functions, rather than being limited to the hardware architecture.

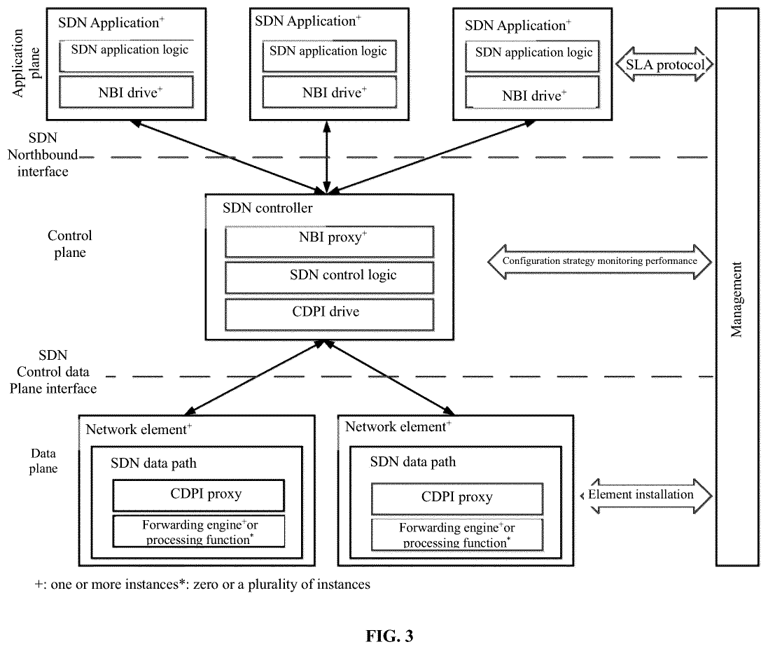

FIG. 2 is a schematic diagram of an NFV architecture used in the method for optimizing a cross-domain deployment of an SFC based on VNF migration provided by the present invention. As shown in FIG. 2, the NFV architecture include:
a VNF composer, a VNF manager, a virtualized infrastructure manager, and a virtual infrastructure, where the VNF composer is configured to coordinate and manage a software resource and a virtualized hardware infrastructure to implement a service network function; the VNF manager is configured to instantiate, expand, terminate, and update the VNF during use of the VNF, and to automatically update a protocol port; and the virtualized infrastructure manager is configured to virtualize and manage configurable computations, networks, and storage resources, and to further collect infrastructure failure information for capacity planning and overall optimization.

Compared with a common network infrastructure, the NFV architecture used has the following advantages:

(1) Network congestion is solved, and the cost is lowered. By migrating the network functions from the dedicated hardware equipment to a virtual resource (for example, a VM or a container), the network congestion problem can be solved, and the cost can be lowered as well.

(2) It is agile to deploy and the yield is improved. The flexibility of the services is optimized, and the agile network function deployment with a high cost benefit is enabled.

(3) The expandability is high. The expandability of the network functions is improved to help InP assist users to complete ever-changing requirements.

In some optional implementations of the embodiment, a software defined network (SDN) and the NFV can work cooperatively. The SDN is capable to separate a network control plane from a bottom data plane and integrate a control function into a network of a logically centralized controller. The NFV and the SDN are mutually beneficial and high in complementarity, and have common features of promoting innovation, openness and competitiveness. The two solutions can be combined to create huge value. For example, the SDN can support the NFV to enhance its performance and simplify its operation, so that the deployment operation is more intuitive and simpler.

To facilitate efficient management and operation, the SDN controls the network through a software program. Specifically, according to an installation rule of the controller, data plane equipment such a switch and a router forward data packets to control the plane controller to monitor a stub network. In the novel pattern, specific purposes (for example, network safety, network virtualization, and green network) can be implemented rapidly in the form of software and are deployed in the network with true flow. In addition, the SDN allows centralized feedback of control logic and makes a superior decision based on a global network view and cross-layer information.

FIG. 3 is a schematic diagram of an SDN architecture used in the method for optimizing a cross-domain deployment of an SFC based on VNF migration provided by the present invention. As shown in FIG. 3, the SDN of an application plane includes SDN application logic and an NBI driver and the like, and manages a system through a protocol. The control plane mainly has a master device controller, and configures a strategy and monitors the performance through NBI proxy, SDN control logic, and a CDPI driver. A network element of a data plane is a data road of the SDN, and the element can be installed. The SDN is capable to separate the control plane from the data plane to realize programmability. Such separation makes the SDN be capable to provide simple and programmable network equipment. Besides, the SDN further provides separation of the control plane and the data plane, so that network control can be performed on the control plane independent from a data stream. Therefore, it is possible to extract network intelligence from switching equipment and place the same on the controller. Moreover, the switching equipment can also be controlled through software without onboard intelligence. Separation of the control plane and the data plane not only provides the SDN with a simpler programming environment, but also provides a greater degree of freedom to exterior SDN behaviors.

S12: the node resource of VNFs and the resource requirement of flow processing are acquired via the NFV architecture.

Via the NFV architecture, when a multi-domain controller (MDC) acquires a service function chain request (SFCR), the MDC will distribute the SFCR to each of intra-domain controllers (IDCs), that is, a master controller in each single domain). Each intra-domain controller will receive the SFCR and forwards the same to a node related to the current intra-domain controller.

S2: the cross-domain deployment of the SFC is performed according to the node resource and the resource requirement.

The SFCs are processed and grouped according to a pre-described order of the VNFs in an Internet service provider (ISP) and a mobile network. The SFC provides users satisfying end to end (E2E) and QoS constraint with specific network services. For example, a safety service in the ISP network can be provided through sequential firewalls (FW), intrusion detection system (IDS), and network address translation (NAT). For example, in a 5G network, as a mode of deploying complex functions and value added services in a mobile packet network, Gi-LAN will provide the value added services by way of efficiently realizing the SFCs.

Therefore, the SFCs will become a component of the network, requiring quite dynamicity and flexibility. Cross-domain deployment of the SFCs is a capacity in different modes and/or a capacity of managing cross-domain deployment of the SFCs.

In the embodiment, step S2 can further include the following step:

S21: a position of the VNF is selected from a plurality of candidate nodes according to the node resource and the resource requirement.

First, a resource of each candidate node needs to be evaluated. This can help determine which nodes have enough resources to support running of the VNF.

Second, a resource requirement of VNF is evaluated. After the resource of each node is determined, it is needed to evaluate the resource requirement of the VNF. This can help determine which nodes have enough resources to satisfy the requirement of the VNF.

Then, the optimal node is selected. Once the node resource and the resource requirement of the VNF are evaluated, it is needed to select the optimal node to run the VNF.

That is to say, the position of the VNF is selected from a plurality of candidate nodes according to the node resource and the resource requirement.

To select the position of the VNF is selected from the plurality of candidate nodes is preparation for VNF migration. Once the optimal node is selected, the VNF is migrated.

S22: the cross-domain deployment of the SFC is performed according to the position of the VNF.

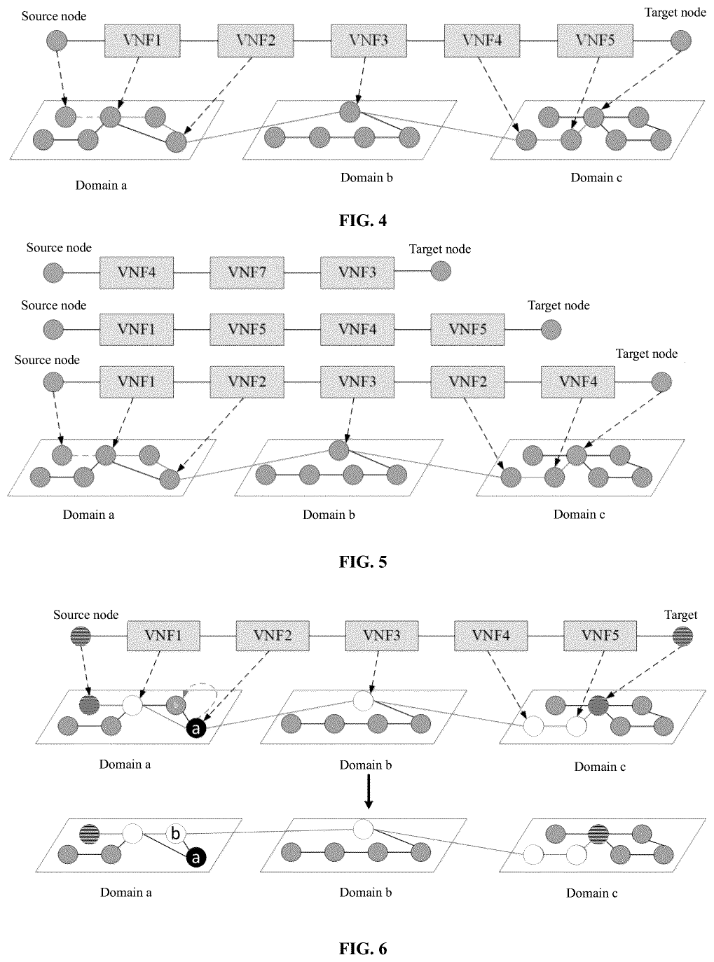

FIG. 4 is a schematic diagram of a deployment of a cross-domain SFC used in the method for optimizing a cross-domain deployment of an SFC based on VNF migration provided by the present invention. As shown in FIG. 4, the nodes exist in different domains. Assuming that the nodes exist in three domains (domains a, b, and c), the VNFs of the SFC are deployed respectively in the three domains through selected node positions. Before deployments of a source node and a target node, nodes to be deployed are selected for deployment according to the principle of proximity. For the cross-domain deployment of the SFC, the VNF position can be selected from the plurality of candidate nodes, which cannot only optimize the network performance (low delay and high bandwidth), but also guarantee high elasticity. Due to large increase of diverse applications, an effective solution is needed at present to realize the flexible deployment of the SFC. Under such a circumstance, the cross-domain deployment of the SFC is a very promising mode, which provides a more appropriate deployment solution for complex and diverse SFCs.

FIG. 5 is a schematic diagram of a plurality of SFCs deployed in a cross-domain manner used in the method for optimizing a cross-domain deployment of an SFC based on VNF migration provided by the present invention. As shown in FIG. 5, when there are a plurality of SFCs, the VNFs of each SFC are deployed respectively in three domains through the selected node positions. When there are a plurality of SFCs in the network, the resources can be flexibly configured. In the cross-domain SFC, the source node and the target node requested by a user need be clear, and an appropriate physical node is selected for each request, so as to deploy the VNFs. On the premise that the stub network can undertake deployment and guarantee the QoS of the SFC, each of the VNFs to be deployed is distributed with the resource and is routed. Therefore, conditions such as resources need to be clear in each domain. To run the cross-domain SFC is mainly to balance privacy and performance. To share detailed network information such as topological structure and resource availability is quite important for efficient cross-domain deployment of the SFC.

S3: an equilibrium point is searched between a delay and a resource consumption rate of the SFC in combination with the delay and the resource consumption rate of the SFC.

In the embodiment, step S3 can further include the following step:

S31: the delay and the resource consumption rate of the SFC that has been deployed in a cross-domain are counted.

The resource consumption rate of each of the VNFS in processing the flow on the node can be computed according to an instant flow for the SFC which has been deployed in a cross-domain manner.

The resource required by the VNF deployed on the node and the resource required by the flow to be processed are divided by the available resource of the node to obtain the resource consumption rate.

S32: an equilibrium is searched between the delay and the resource consumption rate of the SFC.

An equilibrium point is search between the delay and the resource consumption rate of the SFC, the overall network is optimized, the QoS reduction caused by overload of the node, damage of the server or waste of the resource is avoided, and the target is optimized as far as possible, so as to guarantee the delay and resource consumption rate of the SFC during VNFS migration.

S4: optimization processing is performed on the VNF migration according to the equilibrium point to reconstruct the cross-domain deployment of the SFC.

In many network scenarios, the requirement on network services is increased significantly, which results network congestion and lowers the QoS. On the other hand, instability of the network environment is easy to induce network faults, which makes a lot of SFCs cannot provide services normally. Therefore, emergence of a VNF migration strategy solves the problems. VFN migration means that the VNF is removed from a conventional physical machine in the network with the NFV characteristic and is deployed to a better node again, which can solve the problem of unbalanced load in NFV and SDN deployment.

In the prior art, most VNF migration methods only consider a single network condition, rather than separating the VNF migration methods under different network fault conditions. Second, there is a lack of an appropriate priority mechanism, which results in an irregular migration order of the VNF. The important SFC is hardly optimized or recovered. Finally, the conventional VNF migration mechanism only can handle simple network scenarios and is hard to be adapted to network environments with complex network statuses and migration strategies.

In the embodiment, step S4 can further include the following step:

S41: the VNFs needed to be migrated on an original node is removed according to the equilibrium point.

VNF migration is an operation made based on judgment of a real network condition after the deployment of the SFC. When the plurality of SFCs have been deployed in the cross-domain network, the lower resource consumption rate will cause waste of the node resource. Flow surge caused by the dynamic changing network may make some physical nodes overload gradually and further may make the node server fail to affect normal operation of the service. Therefore, VNF migration can be used for service function transfer, fault recovery, energy consumption saving and the like. This method can migrate one or more VNFs which have been deployed in a network topological graph, that is, remove the VNFs needed to be migrated on the original nodes, so that data on an original computer can be eliminated to achieve the purpose of removing the VNFs needed to be migrated on the original nodes.

S42: a redeployment of the SFC is performed on the node located at the equilibrium point.

Searching for other appropriate nodes means redeployment at the node with equilibrium point meaning to reconstruct the SFC, so as to guarantee smooth completion of the service. VNF migration makes the node resource redistributed, so that a link needs to be remapped again. The VNFs needed to be migrated are on the new node and the SFCR is to be completed, that is, at the moment prior to processing the flow, the SFC is redeployed.

In some optional implementations, after the above step S4, the electronic device can execute the following steps: S5: in a case that an intra-domain controller (IDC) detects that the deployed node fails, VNF migration is implemented on the currently deployed node.

After the SFC is deployed, in a case that the IDC detects that a certain deployed node fails, VNF migration is implemented immediately.

FIG. 6 is a schematic diagram of VNF migration when a used node fails in method for optimizing a cross-domain deployment of an SFC based on VNF migration provided by the present invention. As shown in FIG. 6, as a node a has a fault problem and cannot realize a VNF2 function, the system selects a node b for VNF2 for redeployment and realization of the function. Gray indicates that the node has not been deployed by the VNF or has been occupied by the VNFs in other deployed SFC and has not been occupied and deployed by the SFC shown in FIG. 6. White indicates that the VNF in the SFC in FIG. 6 is occupied and deployed. Black indicates a fault node. In this case, the guarantee the continuity of the service, in a case that the original node a where the VNF2 is deployed fails, the IDC will select other nodes capable to provide a deployment resource according to conditions of other nodes in the domain and guarantees that the performance of the SFC after deployment is superior to or comparable to the original performance. Similarly, when in a case that the dynamic changing network causes flow surge in the system to make some physical nodes overload or make the flow stable but the resource consumption rates of some nodes too low, it can be dynamically adjusted in the domain to perform an action of VNF migration. In a case that the physical nodes overload, a plurality of IDCs will configure new nodes capable to undertake deployment and flow processing for the VNFs according to actual conditions, so as to guarantee their normal services; in a case that the IDC detects that the resource consumption rates of some deployed nodes are low, that is, the waste of the resource is caused, the IDC will also search for new nodes improving the resource consumption rates or merge running nodes with low resource consumption rates, which improves the resource using condition while guaranteeing the service delay, so that the service lives of the nodes in a physical network are prolonged.

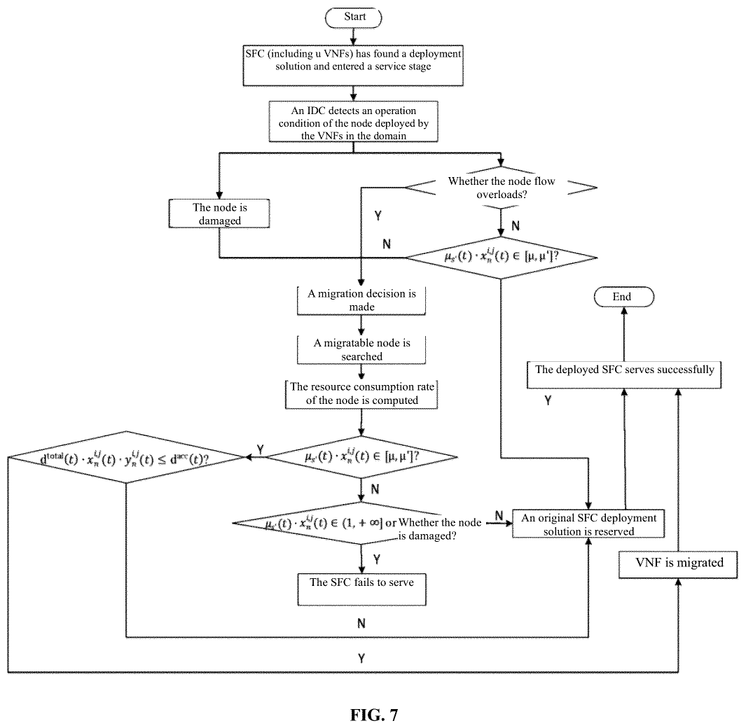

FIG. 7 is a flowchart of the VNF migration used in method for optimizing a cross-domain deployment of an SFC based on VNF migration provided by the present invention. As shown in FIG. 7, an infrastructure in each domain is provided by an infrastructure provider (InP) in each network domain, which can provide resources for flow processing, VNF redeployment, and link remapping.

The network is represented by a undirected graph D=(N, L), where N represents a group of nodes and L is a group of links between two nodes. An nth structural domain in N is represented by Nₙ, and Nₙⁱ∈Nₙ represents an i^{th} node in the n^{th} domain. Iₙ^{ii′} ∈L represents a link from a node Nₙⁱ to a node Nₙ^{i′} in the n^{th} domain and I_{nn′}^{ii′}∈L represents a link from an intra-domain node Nₙⁱ in the n^{th} domain to an intra-domain node N_{n′}^{i′} in the n′^{th} domain. A delay of the physical node where the VNFs are deployed for processing the flow is marked as dₙⁱ a and link delays are marked as dₙ^{ii′} and d_{nn′}^{ii′}. The resources of the physical nodes can be summarized as a total resource, resource for deploying VNF and a resource for processing flows, which are represented by Rₙⁱ, R_{V}^{u}, and C_{n:}ⁱ respectively. Assuming that the SFC entering the model at time t is represented by S={S₁, S₂, . . . , S_{S}} and is formed by u VNFs, each VNF set can be represented as V={v₁, v₂, . . . , vᵤ}, the VNFs have searched for appropriate nodes for deployment in the physical network, and flow processing is performed after successful deployment. Assuming that the resource consumption rate of the time t is μₙⁱ, the resource consumption rate of the SFC in the overall network is μₛ. When the resource consumption rate of the node or link is too low, the resource overloads or the node server is damaged, reduction of the network performance may be caused, so that QoS cannot be guaranteed or the service may even fail. Therefore, in the embodiment, thresholds are set for delays of the resource using condition of the deployment of the SFC, the deployment of the VNFs, and the flow processing, represented by μ and d^{acc}. Only within the appropriate threshold, the performance of the SFC is comparatively excellent.

VNF migration means that in a case that the model triggers conditions to migrate the VNF, the VNF deployed on the original node is immediately migrated to the appropriate node to guarantee the integrity of the SFC and also guarantee the continuity of the service. VNF migration contributes to balancing the energy consumption of each node in the overall network topology, and VNF migration with low flow and operation with part of nodes closed both can achieve the effect of saving the energy. Three migration triggering conditions are considered in the embodiment:
(1) when the deployed node service is damaged, to guarantee normal operation of the SFC, it is needed to migrate the VNF;
(2) in a case that each of the VNFs of the SFC is deployed at an appointed node, the resource consumption rate of the node in processing the flow is obviously low, which brings a consequence of resource waste, so that it is needed to migrate the VNFs according to actual conditions;
(3) in a case that each of the VNFs of the SFC is deployed at the appointed node, the node overloads in processing the flow, which results in that the SFC cannot serve normally, so that it is needed to migrate the VNFs.

In the second point, whether the re-migrated SFC affects the QoS shall also be considered. If variation will cause reduction of QoS, the VNFs are not migrated according to a migration plan. Therefore, in the embodiment, the service success rate of the deployed SFC, the delay and the resource consumption rate of the node of the SFC are optimized reasonably, which not only improves the service success rate of the SFC and the resource consumption rate of the node, but also guarantees that the delay of the SFC does not exceed an appointed threshold. To better describe the problem, an integer linear programming (ILP) model is established according to a target to be optimized in the embodiment.

Node migration: assuming that xₙ^{i,j}(t) is a two-state variable which represents whether the ith VNF in the SFC is successfully migrated to a new node, as shown in equation 1:

$${x}_{n}^{i , j} ( t ) = \{ \begin{matrix}1 , & Successfully migrated and \\ 0 , & Others\end{matrix} . \qquad ( Equation 1 )$$

Link connection: assuming that yₙ^{i,j}(t) is a two-state variable which represents whether a virtual link is remapped, as shown in equation 2.

$${y}_{n}^{i , j} ( t ) = \{ \begin{matrix}1 , & Link remapped ; \\ 0 , & Others\end{matrix} . \qquad ( Equation 2 )$$

In a case that the two-state variables both are 1, it represents that the VNF can be migrated and migrated successfully. In the migration process, the resource consumption rate, the delay, and other limiting conditions need to be considered.

For the successfully deployed SFC, the resource consumption rate μₙⁱ(t) of each of the VNFs in processing the flow on the node can be computed according to an instant flow, as shown in equation 3.

$${μ}_{n}^{i} ( t ) = \frac{{R}_{V}^{u} ( t ) + {C}_{n}^{i} ( t )}{{R}_{n}^{i} ( t )} \qquad ( Equation 3 )$$

R_{V}^{u}(t) represents the resource of deploying the VNF at the time t, Cₙⁱ(t) represents the resource needed to processing the flow at the time t, Rₙⁱ(t) represents the total resource of the node at the time t, and μₙⁱ(t) represents the resource consumption rate of the node at the time t.

In a case that VNFs migration happens in the SFC in the network, in this case, the resource consumption rate of the overall SFC will vary, which is also a standard to measure the quality of the SFC. The resource consumption rates before and after VNFs migration are shown in equations 4 and 5.

$${μ}_{s} ( t ) = \frac{{\sum }_{i ∈ N} {μ}_{n}^{i} ( t )}{N} \qquad ( Equation 4 )$$

$${μ}_{{s}^{′}} ( t ) = \frac{{\sum }_{{i}^{′} ∈ N} {μ}_{n}^{{i}^{′}} ( t )}{N} \qquad ( Equation 5 )$$

μₛ(t) represents the resource consumption rate of the SFC at the time t, μ_{s′}(t) represents the resource consumption rate of the SFC at the time t after VNFs migration, μₙⁱ(t) represents the resource consumption rate of the node at the time t, and μₙ^{i′}(t) represents the resource consumption rate of the node at the time t after VNFs migration.

In a case that μₛ(t) is not in the appointed resource consumption rate threshold, it indicates that it is necessary to migrate the VNFs; similarly, in a case that the migrated μₛ(t) is not in the appointed resource consumption rate threshold, it indicates that the SFC with the migrated VNFs is not necessarily superior to the original SFC, and in this case, unless node overload or damage of the originally deployed node, migration decision is not made, so xₙ^{i,j}(t)=0, yₙ^{i,j}(t)=0, where xₙ^{i,j}(t) represents whether the i^{th} VNF in the SFC is successfully migrated to the new node, and yₙ^{i,j}(t) represents whether the virtual link is remapped.

In a case that each of the VNFs is migrated, the SFC has the delay to process the flow, that is, a time span when the flow is inputted to the SFC and the flow is outputted from the SFC. In the flow processing course, four delays in the process that the SFC processes the flow are considered in the embodiment:
a propagation delay (d_{ii′}^{prop}) represents propagation time when the flow is processed in a link lₙ^{ii′}, which is decided by a distance between the nodes in the domain, as shown in equation 6.

$${d}_{{ii}^{′}}^{prop} = \frac{{g}_{n}^{{ii}^{′}}}{c} \qquad ( Equation 6 )$$

gₙ^{ii′} represents a distance of the link lₙ^{ii′} and c represents a propagation speed of a signal in the link.

A transmission delay (d_{ii′}^{tran}) represents waiting time when the flow is transmitted in the link lₙ^{ii′}, that is, it is set that the transmission delay from VNFᵢ to VNF_{i′} is shown in equation 7.

$${d}_{{ii}^{′}}^{tran} = \frac{{h}_{s , i} ( t )}{{B}_{{ii}^{′}}^{i , v} ( t )} \qquad ( Equation 7 )$$

l_{i,i′}(t) is a length of a data packet after VNFᵢ is processed in the SFC. In a case that a data packet set processed by the SFC is Hₛ={h_{s,0}, h_{s,1}, h_{s,2}, . . . h_{s,i}, . . . }, h_{s,i} represents each data packet to be processed. B_{ii′}^{i,v} is a bandwidth resource requirement of the virtual link from VNFᵢ to VNFⱼ in the SFC.

A processing delay (dᵢ^{pro}) refers to time consumed to achieve a data flow on the VNF in the processing course. The processing delay has something to do with the data flow to be processed by the VNF itself and the computing resource of the deployed node, as shown in equation 8.

$${d}_{i}^{pro} = \frac{{h}_{s , i - 1} ( t )}{{P}_{{ii}^{′}}^{pro} ( t )} \qquad ( Equation 8 )$$

h_{s,i-1}(t) represents the data flow to achieve VNFᵢ. P_{ii′}^{pro}(t) is a rate of processing the data packet by VNFᵢ, which has something to do with the resource based on node energy, as shown in equation 9.

$${d}_{{ii}^{′}}^{pro} ( t ) = {C}_{{ii}^{′}}^{v} ( t ) \cdot ε \qquad ( Equation 9 )$$

ε is a coefficient of the data packet processing rate.

A queuing delay (dᵢ^{q}) refers to time needed waiting for the VNF to process the data packet queuing at the node, as shown in equation 10.

$${d}_{i}^{q} ( t ) = {\sum }_{{N}_{n}^{i} ∈ {N}_{n}} {\sum }_{{s}^{′} \neq s ∈ S} {\sum }_{i , \neq i ∈ {N}_{n}} {x}_{n}^{i , j} ( t ) \cdot {d}_{{ii}^{′}}^{pro} ( t ) \qquad ( Equation 10 )$$

The network is represented by a undirected graph D=(N, L), where N represents a group of nodes and L is a group of links between two nodes. An n^{th} structural domain in N is represented by Nₙ, and Nₙⁱ∈Nₙ represents an i^{th} node in the n^{th} domain. Iₙ^{ii′}∈L represents a link from a node Nₙⁱ to a node Nₙ^{i′} in the n^{th} domain and I_{nn′}^{ii′}∈L represents a link from an intra-domain node Nₙⁱ in the n^{th} domain to an intra-domain node N_{n′}^{i′} in the n′^{th} domain. A delay of the physical node where the VNFs are deployed for processing the flow is marked as dₙⁱ and link delays are marked as dₙ^{ii′} and d_{nn′}^{ii′}. The resources of the physical nodes can be simply summarized as a total resource, resource for deploying VNF and a resource for processing flows, which are represented by Rₙⁱ, R_{V}^{u}, and Cₙⁱ respectively. Assuming that the SFC entering the model at time t is represented by S={s₁, s₂, . . . , sₛ} and is formed by u VNFs, each VNF set can be represented as V={v₁, v₂, . . . , vᵤ}, the VNFs have searched for appropriate nodes for deployment in the physical network, and flow processing is performed after successful deployment. Assuming that the resource consumption rate of the time t is μₙⁱ, the resource consumption rate of the SFC in the overall network is μₛ.

Therefore, an end-to-end delay of the migrated SFC is shown in equation 11.

$${d}^{total} ( t ) = {\sum }_{s ∈ S} {\sum }_{i ∈ {N}_{n}} {d}_{{ii}^{′}}^{pro} ( t ) + {\sum }_{s ∈ S} {\sum }_{{h}_{s , i} ∈ {H}_{x}} {d}_{{ii}^{′}}^{tran} + {\sum }_{{l}_{n}^{{ii}^{′}} ∈ L} {d}_{{ii}^{′}}^{prop} + {\sum }_{s ∈ S} {d}_{{ii}^{′}}^{prop} {d}_{i}^{q} ( t ) \qquad ( Equation 11 )$$

d^{total}(t) represents the end-to-end delay of the migrated SFC and H_{S} represents that the data packet set processed by the SFC is

$${H}_{s} = \{ {h}_{s , 0} , {h}_{s , 1} , {h}_{s , 2} , … {h}_{s , i} , … \} .$$

The delay and the resource consumption rate in the VNFs migration process are jointly optimized in the embodiment. To make VNFs migration successful and guarantee the QoS, the following constraints are needed.

$${\sum }_{{N}_{n}^{i} ∈ {N}_{n}} {x}_{n}^{i , j} = 1 , ∀ v ∈ V \qquad ( Equation 12 )$$

$${\sum }_{{N}_{n}^{i} , {N}_{n}^{{i}^{′}} ∈ {N}_{n}} {y}_{n}^{i , j} = 1 , ∀ v , {v}^{′} ∈ V \qquad ( Equation 13 )$$

$${μ}_{s} ( t ) \leq {μ}_{{s}^{′}} ( t ) \cdot {x}_{n}^{i , j} ( t ) \qquad ( Equation 14 )$$

$${d}^{total} ( t ) \cdot {x}_{n}^{i , j} ( t ) \cdot {y}_{n}^{i , j} ( t ) \leq {d}^{acc} ( t ) \qquad ( Equation 15 )$$

$${μ}_{{s}^{′}} ( t ) \cdot {x}_{n}^{i , j} ( t ) ∈ [ μ , {μ}^{′} ] \qquad ( Equation 16 )$$

$${\sum }_{s ∈ {S}^{τ}} \cdot {μ}_{{s}^{′}} ( t ) + ( 1 - τ ) \cdot {d}^{total} ( t ) \qquad ( Equation 17 )$$

In the following equations 12 and 13, the constraints ensure each VNF can only be distributed to one node in the network and ensure a routing path between the VNFs can only be distributed to a single physical network link. The equation 14 ensures the SFC with successfully migrated VNFs is superior to an originally deployed SFC in terms of the resource consumption rate. The equation 15 ensures the delay of the SFC with successfully migrated VNFs does not exceed the acceptable delay of the SFC. The equation 16 represents that the resource consumption rate must be within a certain threshold, otherwise, the resource consumption rate is low or the node overloads. The equation 17 is a target function of the embodiment.

To avoid a larger burden to the network due to multiple times of VNFs migration, in the embodiment, it is assumed that the migration number of times of any VNF of the SFC entering the system is at most one.

Algorithm 1: VNF migration optimization algorithm:

| | Input: D = (N, L): μₙ [symbol] (t); μₛ(t): μ_{s′}(t) |
|---|---|
| 1 | There are SFC and VNF sets in the network: S= [symbol] s₁,s₂,...,sₛ [symbol] , V= [symbol] v₁,v₂,...,v [symbol] |
| 2 | for s ∈ S v ∈ V do |
| 3 | if Rₙ [symbol] (t)=0 (The node is damaged) |
| 4 | Make a migration decision |
| 5 | else if : μₛ(t) > μ_{s′}(t) · xₙ^{i,j}(t) ∪ μ_{s′}(t) · xₙ^{i,j}(t) ∉ [μ,μ′] |
| 6 | else :Reject migration |
| 7 | end |
| 8 | end |
| 9 | Judge whether it is necessary to redeploy VNFs for the SFC making the migration decision |
| 10 | for s ∈ S v ∈ V do |
| 11 | for V [symbol] ∈ V [symbol] do |
| 12 | if d^{total}(t) · xₙ^{i,j}(t) · yₙ^{i,j} ≤ d^{acc}(t) ∪ μ_{s′}(t) · xₙ^{i,j}(t) ∈ [μ,μ′] |
| 13 | Determine migration |
| 14 | else :Not migrate |
| 15 | end |
| 16 | end |
| 17 | Output: deployment of the SFC after VNFs migration |

[symbol]

indicates data missing or illegible when filed

As shown in the algorithm 1, in an initial network, a certain SFC entering the system is just deployed, and in this case, the flow will traverse all VNFs (line 1). In this case, whether the resource condition of the node deployed by each of the VNFs is sufficient to process the flow is judge. If the node is damaged, in this case, the migration decision must be made; otherwise, judgment is made according to an actual condition (lines 2-4). When the resource consumption rate is not within the threshold, in a case that the resource needed for flow processing exceeds the available resource range of the node, it is decided that migration must be performed; if the resource needed for flow processing does not exceed the available resource range of the node and the resource consumption rate is obviously less than the threshold, it is judged as a resource wasting condition, and migration must be performed; otherwise, the migration decision is not made (lines 5-8). Then, whether it is necessary to redeploy VNFs for the SFC making the migration decision is judged (line 9). The target function of the embodiment is shown in equation 17. In a case that the VNFs make the migration action, whether the delay of the SFC exceeds the maximum acceptable delay and the resource consumption rate is superior to that of an original SFC (the condition that the node is not damaged is compared only) are judged. If the requirement is met, the VNFs are migrated; otherwise, the migration action is not performed (lines 10-16).

In the algorithm of the embodiment, some frequently used parameters such as overall delay of the target function in equation 17 can be computed in advance and is found by a simple table look-up if needed, so that the computing complexity is greatly reduced. A node set in the algorithm is all nodes N_{c} in a certain domain, with c nodes; and a VNFs set is V, with v VNFs. Whether migration is performed is judged by computing the resource consumption rate of each of the VNFs, and the algorithm complexity in this step is O(vn). Similarly, after migration decision is made, each node in the domain shall be judged to find out the appropriate node, and the algorithm complexity in this case is O(cn). After the appropriate node is found, the resource consumption rate and delay of the new SFC decision are computed, and the algorithm complexity in this case is also O(vn). Therefore, the total algorithm complexity in the embodiment is O(cn).

To implement the embodiment, there are the following beneficial effects: first of all, combined with an original deployment of the SFC in a model, whether the VNFs are migrated in the SFC is determined. Migration processing on the VNF is performed in different scenarios, that is, conditions with stable flow, data surge and failure of a node server, so that the delay, the resource consumption rate and the like of the SFC processing the flow are improved.

The present invention can be used in many universal or dedicated computer system environments or configurations. For example, a personal computer, a server computer, a handheld device or a portable device, a tablet device, a multi-processor system, a microprocessor-based system, a set top box, a programmable consumer electronic device, a network PC, a small computer, a large computer, a distributed computing environment including the above any system or device, and the like. The present invention can be described in a common text of a computer executable instruction executed by the computer, for example, a program module. Generally, the program module includes a routine, a program, an object, a component, a data structure and the like which executes a specific task or implements a specific abstract data type. The present invention can also be implemented in the distributed computing environment, and in the distributed computing environment, a remote processing device connected through a communication network executes a task. In the distributed computing environment, the program module can be located in local and remote computer storage media including the storage device.

Those of ordinary skill in the art can understand that all or part of flows in the embodiment method is implemented by instructing related hardware via the computer readable instruction. The computer readable instruction can be stored in a computer readable storage medium. When the program is executed, it can include flows of the embodiments of the above methods. The storage medium can be a nonvolatile memory medium such as a magnetic disk, an optical disk, a read-only memory (ROM) or a random access memory (RAM) and the like.

It will be appreciated that although various steps in the flowchart of drawings are shown sequentially as indicated by the arrows, these steps are not necessarily performed sequentially as indicated by the arrows. Unless explicitly stated otherwise herein, the steps are not performed in a strict order limitation, and the steps may be performed in other orders. Moreover, at least part of the steps in the flowchart can include a plurality of substeps or phases that are not necessarily executed at the same time, but can be performed at different time. The substeps or phases are not necessarily performed sequentially, but can be performed in turn or alternately with at least part of the other steps or the substeps or phases of the other steps.

### Embodiment II

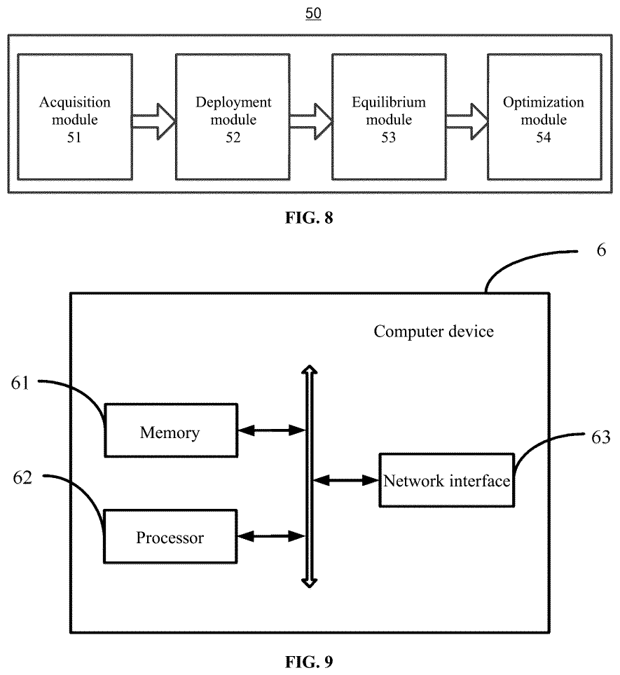

Further referring to FIG. 8, as an implementation of the method shown in FIG. 1, the present invention provides an embodiment of an apparatus for optimizing a cross-domain deployment of a service function chain (SFC) based on virtual network function (VNF). Corresponding to the method embodiment shown in FIG. 1, the apparatus can be specifically applied to various electronic devices.

As shown in FIG. 8, the apparatus 50 for optimizing a cross-domain deployment of an SFC based on virtual network function includes an acquisition module 51, a deployment module 52, an equilibrium module 53, and an optimization module 54. In the apparatus,
the acquisition module 51 is configured to acquire a node resource of VNFs and a resource requirement of flow processing;
the deployment module 52 is configured to perform the cross-domain deployment of the SFC according to the node resource and the resource requirement;
the equilibrium module 53 is configured to search for an equilibrium point between a delay and a resource consumption rate of the SFC in combination with the delay and the resource consumption rate of the SFC; and
the optimization module 54 is configured to perform optimization processing on the VNF migration according to the equilibrium point to reconstruct the cross-domain deployment of the SFC.

To implement the embodiment, there are the following beneficial effects: first of all, combined with an original deployment of the SFC in a model, whether the VNFs are migrated in the SFC is determined. Migration processing on the VNF is performed in different scenarios, that is, conditions with stable flow, data surge and failure of a node server, so that the delay, the resource consumption rate and the like of the SFC processing the flow are improved.

### Embodiment III

To solve the above technical problems, the embodiment of the present invention further provides a computer device. Specifically referring to FIG. 9, FIG. 9 is a block diagram of a basic structure of the computer device provided by the embodiment.

The computer device 6 includes a memory 61, a processor 62, and a network interface 63 in communication connection one another via a system bus. It is to be pointed out that the computer device 6 with the components memory 61, processor 62, and network interface 63 are only illustrated in the drawings. But it is to be understood that not all the shown components are required to be implemented, and more or less components can be implemented alternatively. Those skilled in the art can understand that the computer device herein is a device capable of performing numerical calculation and/or information processing automatically according to preset or stored instructions. Its hardware includes, but is not limited to, a microprocessor, an application specific integrated circuit (ASIC), a field-programmable gate array (FPGA), a digital signal processor (DSP), and embedded device, and the like.

The computer device can be a computing device such as a desktop computer, a notebook computer, a palm computer, and a cloud server. The computer device can be interacted with users by way of a keyboard, a mouse, a remote control, a touch panel or a voice control device.

The memory 61 at least includes a type of readable storage media. The readable storage medium includes a flash, a hard disc, a multimedia card, a card memory (for example, an SD card or DX memory), a random access memory (RAM), a static random access memory (SRAM), a read only memory (ROM), an electrically erasable programmable read-only memory (EEPROM), a programmable read only memory (PROM), a magnetic memory, a magnetic disc, an optical disc and the like. In some embodiments, the memory 61 can be an internal storage unit of the computer device 6, for example, the hard disc or the memory of the computer device 6. In some other embodiments, the memory 61 can also be an external storage device of the computer device 6, for example, a plugged hard disc, a smart media card (SMC), a secure digital (SD) card, a flash card and the like equipped on the computer device 6. Off course, the memory 61 can further include either the internal memory unit or the external storage device of the computer device 6. In the embodiment, the memory 61 is usually used to store an operating system and various application software installed in the computer device 6, for example, a computer readable instruction of the method for optimizing a cross-domain deployment of an SFC based on virtual network function and the like. In addition, the memory 61 can further be used for temporarily storing data that have been outputted or are to be outputted.

The processor 62 in some embodiments can be a central processing unit (CPU), a controller, a microcontroller, a microprocessor or another data processing chip. The processor 62 is usually used for controlling overall operations of the computer device 6. In the embodiment, the processor 62 is used to run the computer readable instruction or processed data stored in the memory 61, for example, run the computer readable instruction of the method for optimizing a cross-domain deployment of an SFC based on virtual network function.

The network interface 63 can include a wireless network interface or a wired network interface. The network interface 63 is usually used for establishing communication connections between the computer device 6 and other electronic devices.

To implement the embodiment, there are the following beneficial effects: first of all, combined with an original deployment of the SFC in a model, whether the VNFs are migrated in the SFC is determined. Migration processing on the VNF is performed in different scenarios, that is, conditions with stable flow, data surge and failure of a node server, so that the delay, the resource consumption rate and the like of the SFC processing the flow are improved.

### Embodiment IV

The present invention further provides another implementation, a computer readable storage medium, having a computer readable instruction stored therein, where the computer readable instruction can be executed by at least one processor, so that the at least one processor implements steps of the method for optimizing a cross-domain deployment of a service function chain (SFC) based on virtual network function (VNF) migration.

To implement the embodiment, there are the following beneficial effects: first of all, combined with an original deployment of the SFC in a model, whether the VNFs are migrated in the SFC is determined. Migration processing on the VNF is performed in different scenarios, that is, conditions with stable flow, data surge and failure of a node server, so that the delay, the resource consumption rate and the like of the SFC processing the flow are improved.

According to the descriptions in the above implementations, a person skilled in the art may clearly learn that the method according to the foregoing embodiment may be implemented by relying on software and a commodity hardware platform or by using hardware. Based on this understanding, the technical solution of the present invention can be substantially reflected in the form of a software product or the part making contribution to the prior art can be reflected in the form of the software product. The computer software product is stored in a storage medium (such as an ROM/RAM, a magnetic disc, and an optical disc), including a plurality of instructions to enable a terminal device (can be a mobile phone, a computer, a server, an air conditioner or a network device) to execute the methods of the embodiments of the present invention.

Apparently, the above described embodiments are merely some, rather than, all of the embodiments of the present invention. The preferred embodiments of the present invention are given in the drawings and do not limit the patent scope of the present invention. The present invention can be implemented in various different forms. Rather, these embodiments are provided, so that the content disclosed in the present invention will be understood more thoroughly and comprehensively. Although the present invention is described in detail with reference to the above embodiments, those skilled in the art still can modify the technical solution recorded by the above embodiments or replace part of technical characteristics equivalently. Equivalent structures made by means of the contents of the specification and drawings of the present invention are applied to other related technical fields directly or indirectly, which is, in a similar way, in the protection scope of the patent of the present invention.

1. A method for optimizing a cross-domain deployment of an SFC (Service Function Chain) based on VNF (Virtual Network Function) migration, comprising the following steps:
acquiring a node resource of VNFs and a resource requirement of flow processing;
performing the cross-domain deployment of the SFC according to the node resource and the resource requirement;
searching for an equilibrium point between a delay and a resource consumption rate of the SFC in combination with the delay and the resource consumption rate of the SFC; and
performing optimization processing on the VNF migration according to the equilibrium point to reconstruct the cross-domain deployment of the SFC;
wherein the step of searching for an equilibrium point between a delay and a resource consumption rate of the SFC in combination with the delay and the resource consumption rate of the SFC specifically comprises: counting the delay and the resource consumption rate of the SFC that has been deployed in a cross-domain; searching for an equilibrium between the delay and the resource consumption rate of the SFC; and
making joint optimization for the delay and the resource consumption rate in the migration process of the VNFs, wherein constraints ensure that each VNF can only be distributed to one node in a network and ensure that a routing path between the VNFs can only be distributed to a single physical network link, the constraints ensure that the SFC with the successfully migrated VNFs is superior to an originally deployed SFC in terms of resource consumption rate, and the constraints ensure that the delay of the SFC with the successfully migrated VNFs does not exceed an acceptable delay of the SFC, wherein the resource consumption rate is constrained within a certain threshold.

2. The method for optimizing a cross-domain deployment of an SFC based on VNF migration according to claim 1, wherein the step of acquiring a node resource of VNFs and a resource requirement of flow processing specifically comprises:
constructing an NFV architecture; and
acquiring the node resource of VNFs and the resource requirement of flow processing via the NFV architecture.

3. The method for optimizing a cross-domain deployment of a service function chain (SFC) based on virtual network function (VNF) migration according to claim 1, wherein the step of performing the cross-domain deployment of the SFC according to the node resource and the resource requirement specifically comprises:
selecting a position of the VNF from a plurality of candidate nodes according to the node resource and the resource requirement; and
performing the cross-domain deployment of the SFC according to the position of the VNF.

4. The method for optimizing a cross-domain deployment of an SFC based on VNF migration according to claim 1, wherein the step of performing optimization processing on the VNF migration according to the equilibrium point to reconstruct the cross-domain deployment of the SFC specifically comprises:
removing the VNFs needed to be migrated on an original node according to the equilibrium point; and
performing a redeployment of the SFC on the node located at the equilibrium point.

5. The method for optimizing a cross-domain deployment of an SFC based on VNF migration according to claim 2, wherein the NFV architecture comprises:
a VNF composer, a VNF manager, a virtualized infrastructure manager, and a virtual infrastructure, wherein the VNF composer is configured to coordinate and manage a software resource and a virtualized hardware infrastructure to implement a service network function; the VNF manager is configured to instantiate, expand, terminate, and update the VNF during use of the VNF, and to automatically update a protocol port; and the virtualized infrastructure manager is configured to virtualize and manage configurable computations, networks, and storage resources, and to further collect infrastructure failure information for capacity planning and overall optimization.

6. The method for optimizing a cross-domain deployment of an SFC based on VNF migration according to claim 1, wherein after the step of performing optimization processing on the VNF migration according to the equilibrium point to reconstruct the cross-domain deployment of the SFC, the method further comprises:
in a case that an intra-domain controller (IDC) detects that the deployed node fails, implementing the VNF migration on a currently deployed node.

7. An apparatus for optimizing a cross-domain deployment of an SFC based on VNF migration, comprising:
an acquisition module, configured to acquire a node resource of VNFs and a resource requirement of flow processing;
a deployment module, configured to perform the cross-domain deployment of the SFC according to the node resource and the resource requirement;
an equilibrium module, configured to search for an equilibrium point between a delay and a resource consumption rate of the SFC in combination with the delay and the resource consumption rate of the SFC; and
an optimization module, configured to perform optimization processing on the VNF migration according to the equilibrium point to reconstruct the cross-domain deployment of the SFC;
wherein the equilibrium module further comprises a counting module, a searching module, and an optimization module, wherein the counting module is configured to count the delay and the resource consumption rate of the SFC that has been deployed in a cross-domain manner; the searching module is configured to search for an equilibrium between the delay and the resource consumption rate of the SFC; and the optimization module is configured to make joint optimization for the delay and the resource consumption rate in the migration process of the VNFs to constrain and ensure that each VNF can only be distributed to one node in a network and ensure that a routing path between the VNFs can only be distributed to a single physical network link, constrain and ensure that the SFC with the successfully migrated VNFs is superior to an originally deployed SFC in terms of resource consumption rate, and constrain and ensure that the delay of the SFC with the successfully migrated VNFs does not exceed an acceptable delay of the SFC, wherein the resource consumption rate is constrained within a certain threshold.

8. (canceled)

9. (canceled)
